(19) United States
(12) Patent Application Publication
(10) Pub. No.: US 2007/0244827 A1
(43) Pub. Date: Oct. 18, 2007

(54) Method for Securing a Hard Drive and Preventing Cloning or Tampering Attacks

(75) Inventors: Brant L. Candelore, Escondido, CA (US); Toshiro Ozawa, San Diego, CA (US)

Correspondence Address: BLAKELY SOKOLOFF TAYLOR & ZAFMAN, 1279 OAKMEAD PARKWAY, SUNNYVALE, CA, 94085-4040, US

(73) Assignees: SONY CORPORATION, Tokyo (JP); SONY ELECTRONICS, INC., Park Ridge, NJ (US)

(21) Appl. No.: 11/618,507

(22) Filed: Dec. 29, 2006

Related U.S. Application Data
(60) Provisional application No. 60/793,399, filed on Apr. 19, 2006.
(60) Provisional application No. 60/793,293, filed on Apr. 18, 2006.

(51) Int. Cl. H04L 9/00

(52) U.S. Cl. 705/59

(57) ABSTRACT

According to one embodiment, a system and method is described for preventing cloning or tampering of a storage medium. This anti-cloning or tampering mechanism involves hashing and storing all the up-to-date content digital rights state information in a different storage medium and later comparing it to a calculated hash of the same information. Another embodiment stores that keyed or encrypted version of the hash including storage medium attributes on the storage medium itself. Access to the content, and to an optional content encryption key, if the content is encrypted is conditioned on comparing the stored storage medium attributes with the live attributes to determine if it is the same drive.

### CROSS-REFERENCE TO RELATED APPLICATIONS

This application claims the benefit of priority on U.S. Provisional Patent Application No. 60/793,399, filed on Apr. 19, 2006.

### BACKGROUND

1. Field

Embodiments of the invention relate to the field of security. More specifically, one embodiment of the invention relates to a system and method for preventing cloning or tampering of a storage medium such as a hard drive.

2. General Background

Over the past few years, analog-based entertainment has rapidly given way to its digital counterpart. High-definition television (HDTV) broadcasts are now becoming commonplace, with the goal for all programming to be HDTV broadcasts. Similarly, greater usage and reliance on the Internet and the World Wide Web for digital data, such as digitized music and video, have resulted in an increased volume of downloadable audio and/or audio-visual files.

Simultaneously with, and in part due to this rapid movement toward digital communications, there has been a significant increase in the usage of digital recording devices. For instance, hard disk-based recording units such as personal video recorders and computer hard disk drives are merely representative of the digital recording devices that are capable of producing high quality recordings, without the generational degradation (i.e., increased degradation between successive copies) known in the analog counterparts.

As a result, due to fears of unauthorized and uncontrolled copying of digital content, content providers such as the motion picture and music industries have become reluctant in providing unfettered availability of digital content for purchase and downloading. One reason is that hard disk drives can be cloned (i.e. copied in their entirety) or specific data can be tampered with. For example, content might be downloaded to a hard disk drive with the ability to securely make a copy on a DVD. By repeatedly cloning a hard disk drive, unlimited DVD copies might be achievable. Similarly, content with limited playback capability, after cloning, might be altered to be played an unlimited number of times. There are many types of attacks available that exploit the insecurity of the state of digital rights stored with the content on the storage medium.

### BRIEF DESCRIPTION OF THE DRAWINGS

Embodiments of the invention are illustrated by way of example and not by way of limitation in the accompanying drawings, in which like references indicate similar elements and in which:

FIG. 1 is an exemplary embodiment of a data storage system;

FIG. 2 is a first embodiment of a system for preventing cloning of a storage medium;

FIG. 3 is an illustrative embodiment of information used as copy protection including digital rights associated with the digital content and attributes pertaining to the storage medium;

FIG. 4A is an exemplary embodiment of a first encryption scheme;

FIG. 4B is an exemplary embodiment of a second encryption scheme;

FIG. 4C is an exemplary embodiment of an encryption scheme for digital rights and attributes of the storage medium;

FIG. 4D is an exemplary embodiment of an encryption scheme for the content key;

FIG. 5 is an exemplary flowchart of the first embodiment of the anti-cloning technique is shown; and

FIG. 6 is a second embodiment of a system for preventing cloning of a storage medium.

### DETAILED DESCRIPTION

Various embodiments of the invention relate to a system and method for preventing the cloning or tampering of a storage medium by hashing and then encrypting the operational state for content to be stored within the storage medium using attributes of the storage medium and/or using a separate storage device such as flash memory mounted on the motherboard for example. The operational state of content relates to the current digital rights of the content such as the number of remaining plays or time allowed, which can change as the rights get used up and the content is “consumed”.

As described herein, cloning or tampering of a storage medium may be prevented by hashing and storing some or all of the up-to-date digital rights state information for the stored content in a different storage medium to produce a resultant hash value. The resultant hash value later being compared to a hash value computed for the same information currently on the storage medium.

According to another embodiment of the invention, a keyed or encrypted version of a hash of the up-to-date digital rights state information and encrypted storage medium attributes on the storage medium itself. In this embodiment, access to the content, and to an optional content encryption key if the content is encrypted, is conditioned on successful comparison of the hash value with a calculated hash value of the current digital rights state information and of the stored attributes with the current attributes of the storage medium to determine if it is the same drive and whether the content has been tampered.

The embodiments of the invention described herein can be used with other techniques for securing content on the hard drive such as using a unique, secret encryption key for each device or Digital Rights Management (DRM) techniques which effectively “locks” content to a particular device. These embodiments of the invention are designed to prevent cloning to another hard drive and even to prevent tampering, e.g. copying of data back into the original hard drive which other security technologies do not address. While these anti-cloning and anti-tampering mechanisms are described for protecting a hard drive, it is contemplated that such mechanisms can be applied to a number of other storage mediums such as flash memory, a compact disk (CD), a digital versatile disk (DVD), a Blu-Ray® disk, or the like.

In the following description, certain terminology is used to describe features of the invention. For instance, “digital content” may include, but is not limited or restricted to a digitized image, audio, video or any combination thereof. The term “component” is representative of hardware and/or software configured to perform one or more functions.

Examples of “software” include a series of executable instructions in the form of an application, an applet, routine, or even one or more executable instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory), a floppy diskette, an optical disk (e.g., compact disk or digital video disc “DVD”), a hard drive disk, tape, or the like.

The term “decrypt” and varying forms thereof is generally defined as the transformation of data from an obfuscated format (e.g., encrypted, scrambled, etc.) to a perceivable format (e.g., viewable and/or audible). Likewise, the term “encrypt” and varying forms thereof is generally defined as the transformation of data from a perceivable format to an obfuscated format.

The term “digital rights” generally refers to the control of access to and/or usage of digital content. Such control may involve usage rules such as restrictions on the number of times, the amount of time or when digital content can be played back, restrictions or prohibition of the copying or moving of content from one device or location to another, restrictions on transcoding or transrating of the digital content, restrictions on the downstream link encryption and security technology which may be used such as Digital Transmission Copy Protection (DTCP) or High Bandwidth Digital Copy Protection (HDCP), restrictions on where the content may be played back such as regional coding on DVDs, and the like. Digital rights may change as the initial rights get used up. For example, after certain content has been played back three (3) out of a possible five (5) times, there are only two (2) plays left. Another example of digital rights that get used up is when there is only 12 hours left in a 24 hour “rental” period.

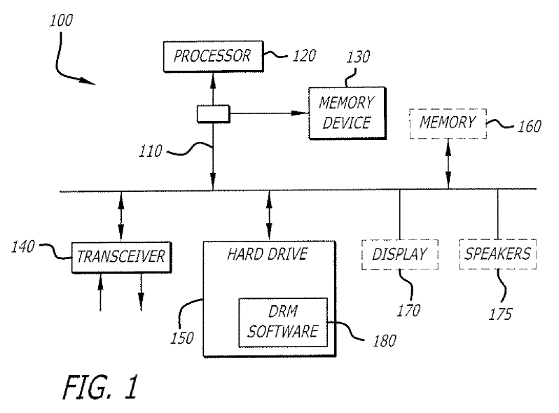

Referring to FIG. 1, an exemplary embodiment of a data storage system 100 is shown. Data storage system 100 comprises an interconnect 110 that is used to establish communications with a plurality of components such as a processor 120, a semiconductor memory device 130, a transceiver 140 and a hard drive 150. As an optional component, a non-volatile, electrically erasable memory 160 (e.g., flash memory) may be implemented within data storage system 100 and configured for storage or a representation of both (i) digital rights state information associated with the stored content and (ii) attributes of hard drive 150. Of course, it is contemplated that the digital rights and attributes may be stored in hard drive 150 in lieu of their representation (e.g., hash value, CRC value, encrypted value, etc.) of the digital rights and attributes. Also, data storage system 100 may include a playback device (e.g., display 170 and/or speakers 175) in order to playback processed digital audio and/or video signals.

Various types of digital content may be downloaded into hard drive 150 for storage and subsequent retrieval for playback. For instance, where transceiver 140 operates as a communication interface to the Internet, digital music and video may be downloaded from a web server hosting a website. Where transceiver 140 operates as a physical connector, such as a universal serial bus (USB) port or IEEE 1394 port for example, digital content may be downloaded from an audio-recording device (e.g., MP3 player), a video-recording device (e.g., digital recorder), and/or an image-recording device (e.g., digital camera, cellular phone, etc.). Where transceiver 140 operates as a wireless communication interface, digital content may be downloaded from any device with wireless transmission capability such as Bluetooth® enabled devices and WiFi-enabled devices. Where transceiver 140 operates as a broadcast tuner and demodulator, digital content may be downloaded from cable, satellite and telco transmissions, and the like.

As shown, incoming signaling is received by transceiver 140, which routes information extracted from the incoming signal to processor 120 via interconnect 110. The information includes digital content and digital rights such as usage rules associated with the digital content. Interconnect 110 may include, but is not limited to electrical wires, optical fiber, coaxial cable, a wireless link established by wireless signaling circuitry, or the like. Interconnect 110 is further able to route some of all of the information to hard drive 150 or to any other storage medium in communication with interconnect 110 such as a portable storage device (e.g., USB flash drive, Sony® Memory Stick, compact flash component, etc.) that is directly or indirectly coupled to interconnect 110 and includes memory for storage of digital content.

After receipt of the incoming information, processor 120 extracts the digital content as well as the digital rights associated with incoming digital content for storage within hard drive 150. For instance, processor 120 executes digital rights management (DRM) software 180, which is stored in hard drive 150 as shown and/or memory 130. DRM software 180 controls the decryption of the received digital content when placed in an encrypted format. Of course, it is contemplated that DRM software 180 may also control the encryption of the received digital content before storage in hard drive 150.

In addition to executed DRM software 180, it is contemplated that data storage system 100 may include cryptographic hardware to aid with these decryption and encryption operations. Also, in lieu of processor 120, it is contemplated that the cryptographic operations may be performed by a component independent of processor 120, such as a co-processor, a dedicated encryption/decryption engine, or the like.

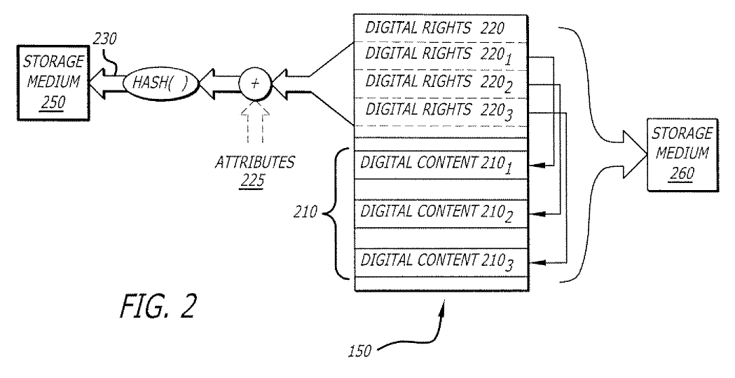

Referring to FIG. 2, a first embodiment of a system for preventing cloning or tampering of a storage medium is shown. Herein, the storage medium (e.g., hard drive 150 of FIG. 1) receives and stores digital content 210 as well as digital rights 220 associated with content 210. More specifically, digital rights 220₁ pertaining to digital content 210₁ may be optionally encrypted and stored within hard drive 150. Similarly, digital rights 220₂ and 220₃ pertaining to digital content 210₂ and 210₃ may be optionally encrypted and stored within hard drive 150. According to this embodiment of the invention, digital rights 220₁-220₃ may be aggregated so that one-way hash and other operations can be performed on digital rights 220 as a collective unit.

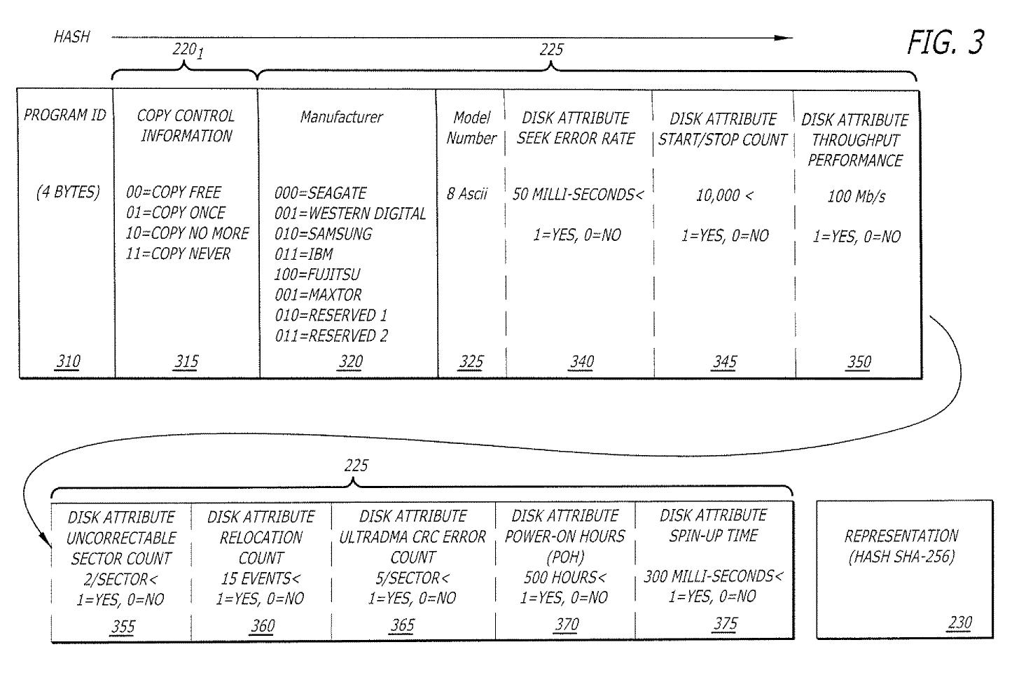

As shown, in FIG. 3, an illustrative embodiment of information used as copy protection such as content digital rights state information 220₁ associated with digital content 210₁ and optional attributes 225 pertaining to hard drive 150 is shown. Attributes 225 may include substantially static or threshold values, namely values after which there would be no further change and/or any changes to such values is not expected for a prolonged time period, for certain characteristics associated with hard drive 150 as described below in detail.

According to this embodiment of the invention, digital rights 220₁ include copy control information 315 while attributes 225 are represented as a plurality of Self-Monitoring, Analysis and Reporting Technology (SMART) attributes associated with hard drive 150 of FIG. 2. SMART attributes 225 are designed to monitor the condition and reliability of hard drive 150. However, it is contemplated that any other type of unchanging attribute of hard drive 150 may be utilized.

Attributes 225 are not required for the hash calculation because a different storage medium (e.g. memory 160 of FIG. 1) may be used to store a representation (e.g. hash value) of up-to-date content digital rights state information. Including attribute 225, however, improves the security of the data storage system by helping to minimize the chance of an attack.

Herein, as shown, program identifier 310 is stored to provide programming information associated with the digital content. For example, the programming information may be a unique identifier for the movie, news broadcast, television programming, or the like. Manufacturer code 320 and model number 325 identify a manufacturer and model number (e.g., serial number) of storage medium 200 of FIG. 2, respectively.

Copy control information 315 constitutes usage rules for digital content 210₁, namely whether digital content 210₁ can be copied without restriction (Copy Free “00”), copied once (Copy Once “01”), copied no more (Copy No More “10”), or never copied (Copy Never “11”). These usage rules may be a subset of digital rights 210₁ and may be left in the clear on the hard disk drive 150 to allow for easy comparison and analysis by the anti-cloning system. The values of the usage rules, digital rights (if used and present) are incorporated in hash value 230 of FIG. 2.

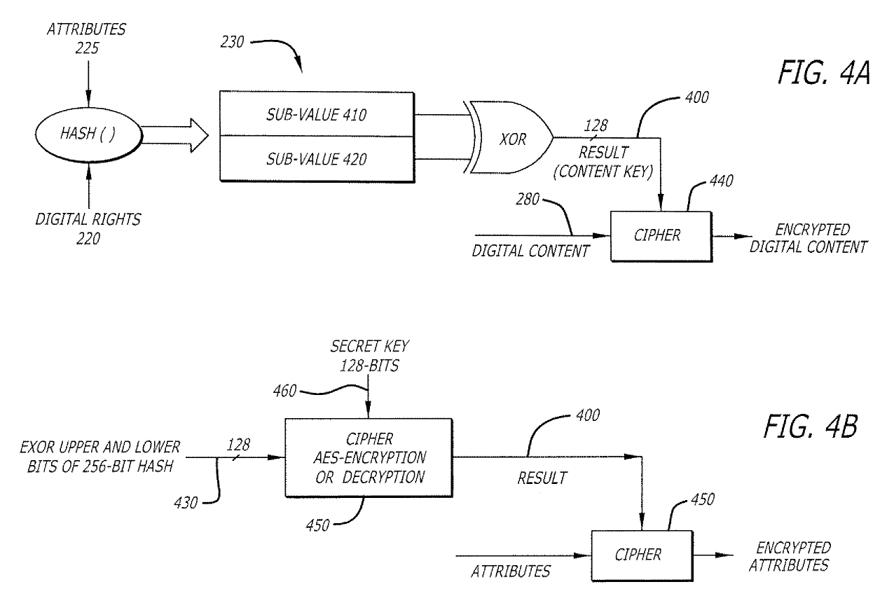

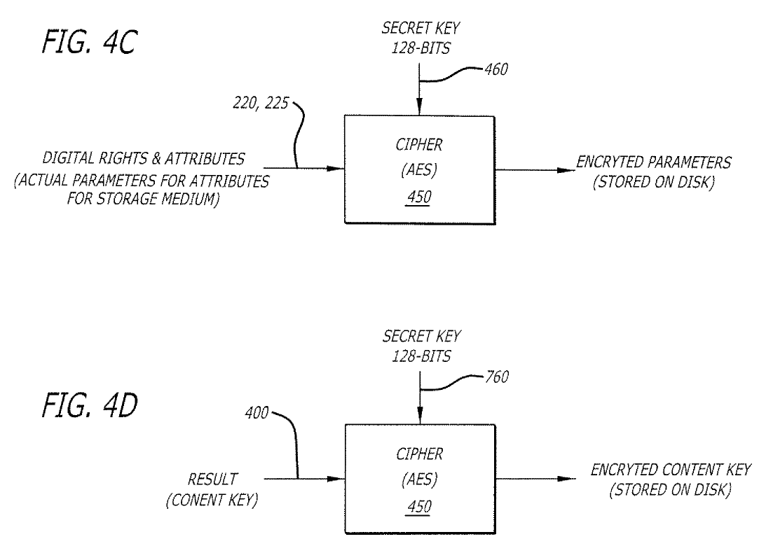

According to another embodiment of the invention using the storage medium 150 itself, attributes 225 may be encrypted using a secret key 460 (see FIG. 4C) and may be configured with (i) the actual measured attributes for the storage medium (e.g., hard drive 150), or as shown, (ii) pseudo attributes which identify whether the attributes are below or above a particular pre-assigned threshold (hereinafter referred to as “threshold attributes”). The reason for using threshold attributes and encryption instead of a hash value 230 is that many attributes are dynamic and will change over time, normally measured degradation (e.g., higher error rate, slower seek time, etc.) as hard drive 150 gets older as determined by Power-on Hours (PO).

The resolution of POH can be down to the second depending on the manufacturer, and is useful in tracking changes in the up-to-date digital rights state information of the content on a second-by-second basis if needed. For example, if the system wants to track that the playback time for content was being used up, by recording the POH attribute change every minute to the separate storage medium would force the content on the storage medium to “age”, and would only allow a hacker to extend the time by at most one minute through a cloning or tamper attack.

Therefore, the threshold attributes can be used effectively to detect cloning to different hard drives or tampering, e.g. writing back to the original hard drive.

According to one embodiment of the invention, attributes 225 include one or more of the following attributes as shown in Table A below, and are not limited or restricted to these attributes. The following attributes associated with hard drive 150 are presented in FIG. 3 for illustrative purposes and operate as threshold values to provide substantially static values for subsequent comparison with current attributes of the hard drive to determine if it is the same drive and whether the content has been tampered. These threshold values include: Seek error rate 340, Start/Stop Count 345, Throughput Performance 350, Uncorrectable Sector Count 355, Reallocation Event Count 360; UltraDMA CRC Error Count 365; Power-On Hours 370; and Spin-Up time 375.

TABLE A

| ATTRIBUTES | DESCRIPTION |
|---|---|
| Seek Error Rate | Rate of seek errors of the drive |
| | magnetic heads. More seek |
| | errors indicates a worsening |
| | condition of the hard drive. |
| Throughput Performance | Overall (general) throughput |
| | performance of the hard drive. |
| | If the value of this attribute |
| | is deceasing, there is a higher |
| | than normal probability of hard |
| | drive troubles. |
| Read Error Rate | Depending of read errors and |
| | disk surface condition, this |
| | attribute indicates the rate of |
| | hardware read errors that |
| | occurred when reading data. |
| | Lower values indicate that |
| | there is a problem with |
| | components of the hard drive. |
| Spin-Up Time | Average time of spindle spin up |
| | (from zero revolutions per |
| | minute “RPM” to fully |
| | operational). Attribute in |
| | milliseconds or seconds. |
| Start/Stop Count | This value of this attribute is |
| | a count of hard disk spindle |
| | start/stop cycles. |
| Reallocated Sectors Count | A count of reallocated sectors. |
| | When the hard drive finds a |
| | read/write/verification error, |
| | it marks this sector as |
| | “reallocated” and transfers (or |
| | remaps) data to a special |
| | reserved area. The more |
| | sectors that are reallocated, |
| | the more of a decrease in |
| | read/write speed. |
| Read Channel Margin | Margin of a channel while |
| | reading data. |
| Seek Time Performance | Average performance of seek |
| | operations of the magnetic |
| | heads. If this attribute is |
| | decreasing, it is a sign of |
| | problems in the hard drive. |
| Power-On Hours | A count of hours in power-on |
| | state. The value of this |
| | attribute shows total count of |
| | hours (or minutes, or seconds, |
| | depending on manufacturer) in |
| | power-on state. A decrease of |
| | this attribute value to the |
| | critical level (threshold) |
| | indicates a decrease of the |
| | mean time between failures. |
| Spin Retry Count | A count of retries of spin |
| | start attempted. This |
| | attribute stores a total count |
| | of the spin start attempts to |
| | reach the fully operational |
| | speed. A decrease of this |
| | attribute value is a potential |
| | sign of problems in the hard |
| | drive. |
| Recalibration Retries | This attribute indicates the |
| | number of times recalibration |
| | was requested (under the |
| | condition that the first |
| | attempt was unsuccessful). A |
| | decrease of this attribute |
| | value is a sign of problems in |
| | the hard drive. |
| Device Power Cycle Count | This attribute indicates the |
| | count of full hard drive power |
| | on/off cycles. |
| Soft Read Error Rate | This attribute is the rate of |
| | “program” read errors occurring |
| | when reading data. |
| Load/Unload Cycle | A count of load/unload cycles |
| | into a “landing zone” position |
| | where the head is positioned |
| | and disk is not spinning. |
| Reallocation Event Count | A count of remap operations |
| | (transferring data from a bad |
| | sector to the special reserved |
| | area). The value of this |
| | attribute shows the total |
| | number of attempts to transfer |
| | data from reallocated sectors |
| | to the spare area. |
| Current Pending Sector Count | A count of unstable sectors |
| | (waiting or remapping). The |
| | value of this attribute |
| | indicates the total number of |
| | sectors waiting for remapping. |
| Uncorrectable Sector Count | A quantity of uncorrectable |
| | errors. The value of this |
| | attribute indicates the total |
| | number of uncorrectable errors |
| | when reading/writing a sector. |
| | A rise in this value indicates |
| | a less reliable hard drive. |
| UltraDMA CRC Error Count | A quantity of CRC errors during |
| | a data transfer in UltraDMA |
| | mode. |
| Write Error Rate | A write data error rate. This |
| | attribute indicates the total |
| | number of errors found when |
| | writing a sector. |
| Load Friction | Loading on magnetic heads |
| | actuator caused by friction in |
| | mechanical parts of the store. |
| | Only the time when heads were |
| | in the operating position is |
| | counted. |

Referring back to FIG. 2, according to this embodiment of the invention, the aggregated digital rights 220 and optional non-changing attributes 225 pertaining to digital content 210 undergo a one-way hashing operation to produce a hash value 230. Hash value 230 may aggregate digital rights from a group of contents or from a sector of the storage medium. Also, hash value 230 can be individualized for each stored content. Later, if it is determined that tampering has occurred, the content may become inaccessible. If the hash value only pertains to one piece of content or sector, then only that content or sector will be inaccessible.

According to this embodiment of the invention, as shown, hash value 230 is to be stored on a different storage medium 250 than hard drive 150 in order to improve security. However, in a different embodiment, it is contemplated that hash value 230 may be stored within hard drive 150 itself. In this embodiment, attributes 225 would be used unless they are not too dynamic and cannot be used in the hash value 230. When using the hard drive 150 itself, some or all of the storage medium attributes listed in FIG. 3 may be encrypted by secret key 460, in a separate operation from the encryption of the upper and lower bits of hash value 230 described below, which is managed by security software, e.g. DRM software 180, of data storage system 100 of FIG. 1.

If an attempt is made to clone or tamper with the stored contents of hard drive 150, an earlier version of the digital content 210 could be copied onto a different storage medium 260. However, attributes 225 for hard drive 150 would not be copied. Rather, attributes 225 would be fetched by the security (DRM) software in control of storage medium 260. In the event that digital content 210 is encrypted, accessing the encryption key used to encrypt the content will entail examining the storage medium attributes recorded along with the content 210. By examining the “current” attributes and comparing these attributes with the stored attributes of hard drive 150, any attempts to recover digital content 210 will likely be precluded if the attributes between hard drive 150 and storage medium 260 vary (or vary beyond a prescribed threshold of error).

For instance, the DRM software controlling storage medium 260 may rely on different attributes. Hence, in order to authenticate digital content 210 copied onto storage medium 260, the up-to-date digital rights state information for the content underwent a one-way hashing operation to produce a computed value. This value may then be encrypted using secret key 460 to produce result 400. In addition, result 400 may then be used to encrypt the attributes at encryption operation 450 in FIG. 4B. The result 400 can also be used as a content key if the content is encrypted by this security system. It is highly unlikely that, when using a hash value of 128-bits or more, the computed value of modified rights would match a hash value computed based digital rights stored on the hard drive 150.

Likewise, when decrypting the stored attributes and comparing them against the current attributes, the DRM software can determine whether the stored medium is the same or not. Therefore, when digital content 210 is authenticated using the encrypted, computed value based on the up-to-date content digital rights state information and encrypted attributes of hard drive 150, this cloning attack will not succeed since the current drive attributes will not compare properly to the stored decrypted values.

For example, if a drive is not the same manufacturer or the same model number and thus the computed hash values differ, then this is obviously not the same drive, and the DRM software will prevent access to the content. If there are fewer unfixable disk errors than previously recorded, then this is not the same drive. If a drive is younger than what was previously recorded, then this is not the same drive. For this type of comparison, the POH attribute is useful since it can have a resolution down to a second of time. Of course, besides these differing attributes, other differences in digital rights 220 (e.g., copy control information 315, manufacturer code 320 and model number 325 of FIG. 3) may prevent recovery of or access to digital content 210. For example, the content may have simply expired or the number of plays has been exceeded.

In general, as shown in FIG. 4A, digital rights 220 undergo one-way hashing operations to produce hash value 230. According to one embodiment of the invention, hash value 230 (or any recalculation of hash value 230) is used to produce result (content key) 400 for use as an encryption and decryption key or as a value used to access the encryption and decryption key. As discussed previously, it may also be used to encrypt the stored medium attributes 225. More specifically, according to one embodiment of the invention, result 400 is produced from hash value 230.

As an illustrative example, if SHA-256 hash function is used as the one-way hash function, hash value 230 is a 256-bit value. Hash value 230 would be divided into two separate sub-values 410 and 420, which are XOR'ed together to produce result 400. Result 400 may be used as a cryptographic key for a stream cipher 440 through which digital content 210 is now cryptographically protected prior to storage within hard drive 150. It is envision that this security system may only be used to prevent cloning and tampering of the stored medium, mainly to modify the stored digital rights, but not necessarily to encrypt the content as other mechanisms may be used for that.

Alternatively, as shown in FIG. 4B, an input key 430 may be used as an input into a cipher 450 such as a block cipher like Advanced Encryption Standard (AES). A secret key 460 that is normally static and preloaded onto the data storage system is input into cipher 450 along with an input key 430, which was used as content key (or result) 400 in FIG. 4A. This secret key 460 may be different for each data storage system. A resultant value, namely content key 400, is produced and is used as the cryptographic key for stream cipher 450 through which digital content 210 is routed and cryptographically protected before storage.

As shown in FIGS. 4C and 4D, digital rights state information 220 and attributes 225 of the storage medium (e.g., actual or threshold hard drive attributes) are encrypted by cipher 450 using secret key 460. The same operation is performed for encrypting content key 400.

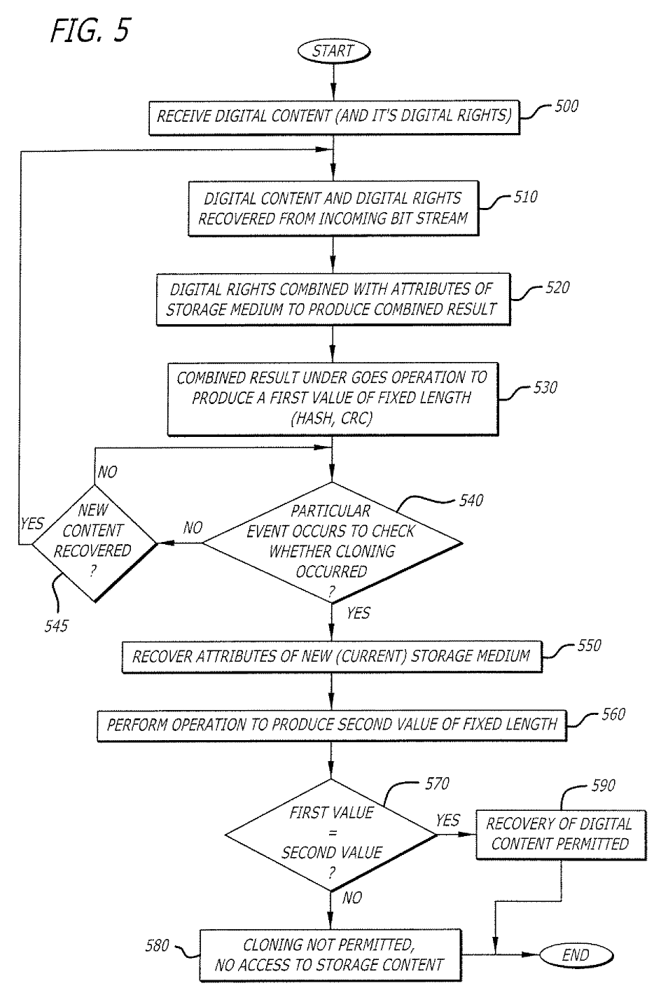

Referring now to FIG. 5, an exemplary flowchart of the first embodiment of the anti-cloning technique is shown. First, digital content is received by a data storage system (block 500). At certain times or in response to a particular event, such as during a power-down event for example, the digital rights state information associated with the digital content is recovered and combined with attributes of a storage medium used by the data storage system (blocks 510 and 520). This combined result may undergo an operation to produce a static value that is subsequent analyzed (block 530). For instance, the static value may be analyzed during the next power-up event to ensure that none of the attributes have been tampered.

According to one embodiment of the invention, the operation performed on the combined result may be a one-way hash function in order to produce a hash value. According to another embodiment of the invention, the operation may be a cyclic redundancy check (CRC) operation to produce a CRC value. It is contemplated that digital rights station information may be encrypted prior to performing the one-way hash or CRC operation as described above.

Thereafter, if the digital content is cloned (copied to another storage medium), in response to a particular event such as a power-up of another data storage system (and the storage medium), the attributes of the current storage medium are recovered (blocks 540 and 550). Otherwise, if additional digital content is received, the first value is updated (block 545).

These attributes undergo hash or CRC operations and are subsequently compared with the static value generated and stored in the first storage medium (blocks 560 and 570). In the event of a failure in the comparison, the digital content cannot be decrypted and recovered (block 580). However, if the comparison is successful, no cloning or tampering has occurred and the system attempts to recover the digital content (block 590).

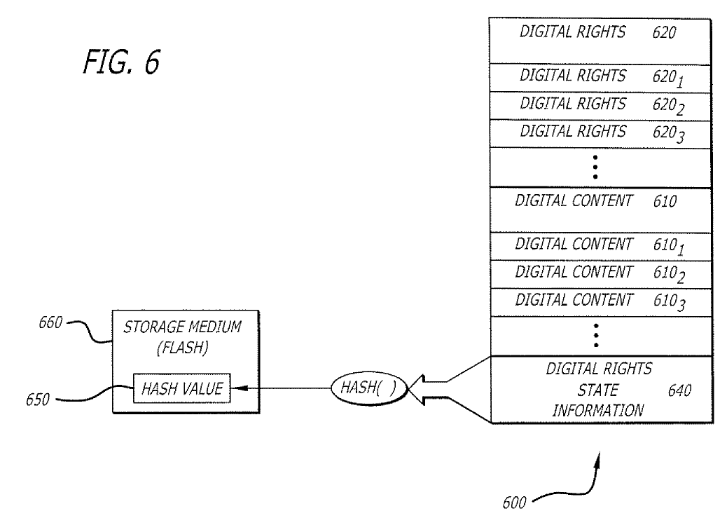

Referring to FIG. 6, a second embodiment of an apparatus for preventing cloning of a storage medium 600 is shown. Herein, storage medium 600 receives and stores digital content 610 as well as digital rights 620 associated with content 610. More specifically, digital rights 620₁ pertaining to digital content 610₁ may be encrypted using information derived from non-changing attributes of storage medium 600 and stored therein. Similarly, digital rights 6202 and 6203 pertaining to digital content 6102 and 6103 may be encrypted and stored within hard drive 150.

In addition, storage medium 600 is adapted with dedicated area to store up-to-date digital rights state information 640. For instance, “state information” 640 includes information that involves a change in the secured operational state of content based on a change in usage or access to digital content 610 stored therein. For instance, when digital content 610₁ is played back and one of digital rights 620₁ limit the number of times digital content 610₁ can be played back. Based on a change in the count value directed to such playback, this constitutes a change in usage or access of digital content 610, namely digital content 610₁. Thus, state information 630 records this change in the secured operational state. Similarly, if content 610 playback is for a certain amount of time, e.g. 24 hours. The state information 630 can record this change in the advancement of time periodically, e.g. every minute or 10 minutes.

However, if digital rights 620₁ did not limit playback of digital content 610₁, any playback would not constitute a change in the secure operational state of the content stored in the data storage system. Hence, state information 630 would not include information directed to playback.

In order to ensure that the most recent changes in the secure operational state are maintained, state information 640 is stored in accordance with a first-in, first-out (FIFO) queuing structure. Thus, the most recent changes in the secure operational state are set and stored in response to a first event (e.g., power-down, hibernate, etc.) and are compared in response to a second event (e.g., power-up, resume, etc.).

Herein, in order to reduce the amount of data stored, up-to-date digital rights state information associated with content 640 undergoes a one-way hashing operation to produce a hash value 650. According to this embodiment of the invention, hash value 650 is stored on a different storage medium 660 (e.g., flash memory) than storage medium 600 (e.g., hard drive).

If an attempt is made to clone or tamper with the contents of storage medium 600, digital content 610, the up-to-date digital rights state information 640 would be copied. On boot-up, the contents of the up-to-date digital rights state information 640 will be hashed and compared to that in the different storage medium 660. If any rights had been used-up between cloning or tamper operations, e.g. number of copies allowed reduced, amount of remaining playback time reduced, then the hash value 650 will differ from the calculated hash from the cloned storage medium. The security software can then decide what to do, e.g. deny access to the content or perhaps reduce the rights to “Copy No More”. It is envisioned that with any electronic system, the hash could somehow get out of sync with the calculated hash from the storage medium as some type of glitch. With such a possibility, it may be desirous to divide the storage medium into sectors—with each sector's up-to-date digital rights state information 620 being hashed and stored in the different storage medium. In such a scenario, only the content from the particular sector with the incorrect calculated hash would be affected.

In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are accordingly to be regarded in an illustrative rather than in a restrictive sense.

What is claimed is:

1. A data storage system, comprising:
a storage medium to store digital content and an up-to-date digital rights state information associated with that content; and
a non-volatile memory to store a representation of the up-to-date digital rights state information for comparison purposes to ensure that information stored on the storage medium has not been copied to another storage medium or re-copied back onto the storage medium.

2. The data storage system of claim 1, wherein the non-volatile memory to store the representation of the up-to-date digital rights state information in response to a first event for comparison with a representation of current digital rights state information stored on the storage medium in response to a second event.

3. The data storage system of claim 1, wherein the representation of the up-to-date digital rights state information comprises multiple representations each corresponding to one or more segments of the storage medium, each segment of the storage medium storing multiple programs.

4. The data storage system of claim 1, wherein the storage medium is a hard disk drive.

5. The apparatus of claim 2, wherein the non-volatile memory is a flash memory.

6. A data storage system, comprising:
a storage medium to store digital content, up-to-date digital rights state information associated with the digital content, an encrypted version of a representation of the up-to-date digital rights state information, and an encrypted version of storage medium attributes; and
a processor to control access to the digital content by decrypting the encrypted version of the storage medium attributes to obtain stored storage medium attributes and comparing the stored storage medium attributes with recovered current attributes of the storage medium to determine whether the digital content was not copied from a different storage medium or re-copied back onto the storage medium.

7. The data storage system of claim 6, wherein the representation and storage medium attributes is encrypted with a secret key managed by a security software running on the data storage system.

8. The data storage system of claim 6, wherein the digital content is encrypted using an encryption key being a function of the stored storage medium attributes.

9. The data storage system of claim 6, wherein the storage medium is a hard drive and one of the stored storage medium attributes used is Power On Hours (POH) attribute.

10. The data storage system of claim 6, wherein the storage medium is a hard drive and at least one of the stored storage medium attributes includes a model number for the hard drive.

11. The data storage system of claim 6, wherein the storage medium is a hard drive and at least one of the stored storage medium attributes includes a threshold value for one of a plurality of Self-Monitoring, Analysis and Reporting Technology (SMART) attributes associated with the hard drive.

12. The data storage system of claim 6, wherein the representation of the up-to-date digital rights state information is a representation of the up-to-date digital rights state information and the storage medium attributes including a Power On Hours (POH) attribute calculated and encrypted periodically for authentication.

13. A method comprising:
encrypting digital content for storage on a storage medium, the digital content being encrypted using an encryption key that is a function of storage medium attributes; and
storing the encrypted digital content on the storage medium.

14. The method of claim 13 further comprising:
performing a one-way hash operation on up-to-date digital rights state information associated with the digital content in order to produce a hash value; and
storing the hash value.

15. The method of claim 14, wherein the one-way hash operation is further performed on attributes of the storage medium.

16. The method of claim 15, wherein at least one of the attributes of the storage medium includes a Power on Hours (POH) attribute.

17. The method of claim 15, wherein prior to storing the hash value, the method further comprising:
encrypting the hash value.

18. The method of claim 14, wherein the performing of the one-way hash operation and the storing of the hash value is in response to a first event.

19. The method of claim 18, wherein the first event is a power-down operation on a data storage system implemented with the storage medium.
